(19) United States
(12) Patent Application Publication
(10) Pub. No.: US 2014/0253458 A1
(43) Pub. Date: Sep. 11, 2014

(54) Method and System for Suggesting Phrase Completions with Phrase Segments

(71) Applicant: Nirmal J. Patel, Mountain View, CA (US)

(72) Inventor: Nirmal J. Patel, Mountain View, CA (US)

(73) Assignee: GOOGLE INC., Mountain View, CA (US)

(21) Appl. No.: 13/187,146

(22) Filed: Jul. 20, 2011

(51) Int. Cl. G06F 17/27; G06F 3/041

(52) U.S. Cl. 345/173; 704/9; 704/E11.001

(57) ABSTRACT

A method is provided for managing phrase completion suggestions in response to text input. The method includes receiving text entered into the computing system, and identifying a first plurality of phrases that each begins with the received text and that each includes a respective phrase segment immediately following the received text. The method further includes displaying a first list of the respective phrase segments of the identified first plurality of phrases without displaying the received text, and receiving input defining a selection of one of the respective phrase segments of the displayed first list.

### BACKGROUND

Unless otherwise indicated herein, the materials described in this section are not prior art to the claims in this application and are not admitted to be prior art by inclusion in this section.

The Internet has become a main source for users searching for information of interest to them. Users of personal computers (PC), such as desktop and laptop computers, search for information by initiating a search query through a search service's web page. To do so, a user can enter one or more search term(s) into an input box or text entry field on the search web page and then initiate a query search based on such entered search term(s). In response to the search query, a web search engine generally returns an ordered list of search results, which may include a title, a universal resource locator (URL) link, and an abstract.

When attempting to perform similar Internet searches on mobile devices, such as cell phones and touch-based computing devices, users encounter difficulties using search technologies and navigation features intended for and adapted to PC size screens. Such difficulties include the inability to display long extensive result lists or suggestions without obstructing displayed text or images and virtual keyboards on corresponding reduced screens. Additionally, search query refinements typically require adding terms to the previously entered search terms, which can be difficult in the relatively small text entry fields provided by these reduced screens.

Therefore, there is a need for a system and method that enable a user to perform Internet searches using display devices with reduced screens while overcoming at least the above discussed limitations.

### SUMMARY

Disclosed herein are improved methods, systems, and devices for suggesting phrase completions with phrase segments.

In one embodiment, in a computing system, a method for managing phrase completion suggestions in response to text input comprises receiving text entered into the computing system, and identifying a first plurality of phrases that each begins with the received text and that each includes a respective phrase segment immediately following the received text. The method further comprises displaying a first list of the respective phrase segments of the identified first plurality of phrases without displaying the received text, and receiving input defining a selection of one of the respective phrase segments of the displayed first list.

In another embodiment, a computing system includes a display unit operable to display a search field and keys constituting a virtual keyboard, a memory unit for storing program instructions executable to perform a method for managing phrase completion suggestions in response to text input, the method comprising: a) receiving text entered into the search field via the virtual keyboard, b) identifying a first plurality of phrases that each begins with the received text and that each include a respective word immediately following the received text, c) displaying a first list of the respective words of the identified first plurality of phrases in the search field without displaying the received text, and d) receiving input defining a selection of one of the respective words of the displayed first list, and a processor operatively coupled to the memory and the display unit, and configured to execute the method.

In another embodiment, a non-transitory computer readable storage medium contains instructions that cause a computing system to perform a method for managing phrase completion suggestions in response to text input.

In yet another embodiment, a head-wearable display device includes a display element for displaying graphical images, an image projecting unit for projecting the graphical images on the display element, a touch pad configured to generate a signal indicative of a touch point contact on the touchpad corresponding to a selection of a term or a word displayed on the display element, a memory unit for storing program instructions executable to perform a method for managing phrase completion suggestions in response to text input, and a processor operatively coupled to the memory, the touchpad, and the image projecting unit, and configured to execute the method.

### BRIEF DESCRIPTION OF THE FIGURES

In the figures:

FIG. 1 is a block diagram illustrating an embodiment of a computing network;

FIG. 2 illustrates exemplary embodiments of mobile devices equipped with reduced display screens;

FIG. 3 illustrates an embodiment of an interface screen associated with a mobile end user device;

FIG. 4 is a flow diagram illustrating an exemplary method for managing phrase completion suggestions in response to text input;

FIGS. 5 A-5 E illustrate an exemplary embodiment of the method of FIG. 4;

FIG. 6 illustrates an embodiment of a head-wearable display device with an integrated input device;

FIG. 7 is a functional block diagram illustrating an example computing device associated with the computing system of FIG. 1; and

FIG. 8 is a schematic diagram illustrating a conceptual partial view of an example computer program associated with the method of FIG. 3.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The methods, systems, and apparatuses or devices disclosed herein generally relate to providing text entry completion suggestions. One scenario involves a user using his/her mobile phone to seek or search for information, associated with a particular topic or subject, on the Internet. As the user begins entering text, describing the sought information, using a virtual keyboard displayed on the reduced screen of the mobile phone, an application stored therein, such as a web browser application, communicates the entered text to an information search engine, associated with an information server accessible via the Internet. The search engine in turn identifies and returns a plurality of phrases that begin with the text entered so far. Because the mobile phone screen lacks display space to present the identified plurality of phrases in full so as to prompt a user selection of one of the phrases, the application program present options of a next phrase segment immediately following the entered text, without the entered text. Upon selection of one the presented phrase segments, the application concatenates the previously entered text with the selected phrase segment and communicates the concatenated text to the search engine, which in turn again identifies and returns another plurality of phrases that begin with the concatenated text. The application program again presents options of a next phrase segment from the newly returned plurality of phrases immediately following the concatenated text, without the concatenated text. This process continues until the user has received the sought information.

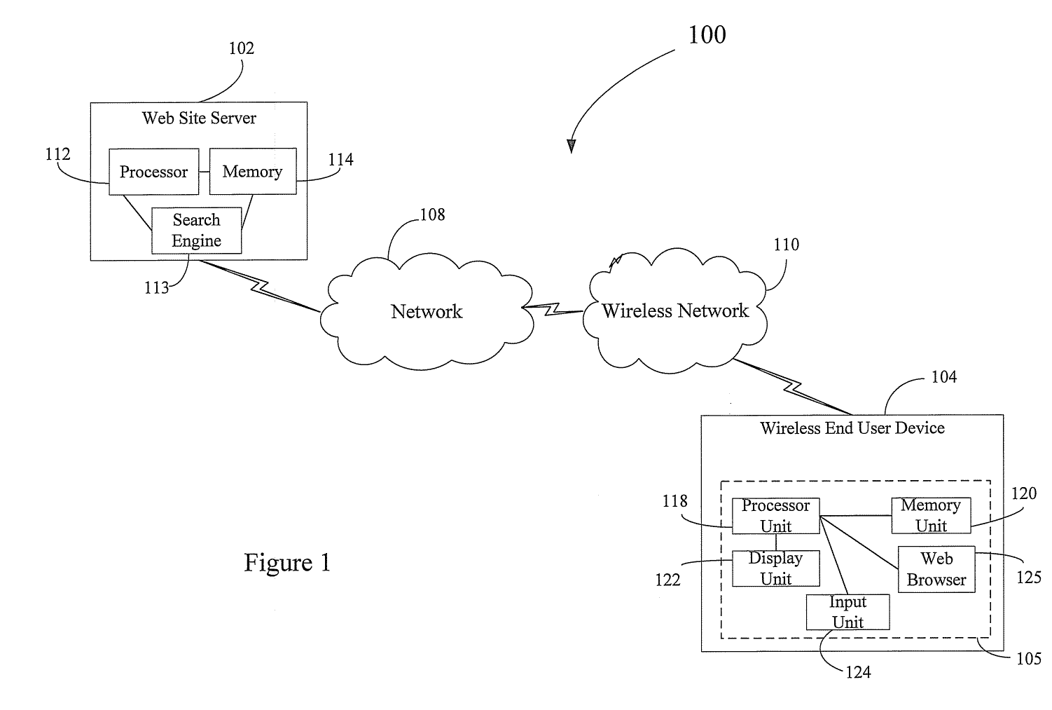

Now referring to FIG. 1, a networked system 100, for implementing the method for providing text entry completion suggestions, is shown. In the exemplary embodiment of FIG. 1, networked system 100 comprises a website server 102, communicatively connected to an end user computing device 104 through a network 108 (e.g. the Internet) and a wireless network 110, such as a cellular network and the like. Although, end user computing device 104 is considered to be a wireless computing device, alternately it may be connected directly to search engine server 102 via network 110 only. As known, the Internet is a computer network consisting of a worldwide network of computer networks that use the TCP/IP network protocols to facilitate data transmission and exchange.

In the depicted embodiment, the website server 102 may include a processor unit 112, a memory unit 114, a search engine 113, and is coupled to a database 116. Search engine 113 is a computer program designed to help locate information by retrieving documents, files located by searching any of a variety of systems of varying size and scope. For example, the search engine may be configured to search multiple computer systems such as computers publishing information on the World Wide Web, to search within a particular website on the World Wide Web, to search a personal computer, or to search any other system. The search engine allows the user to request web pages containing information related to a particular search term or phrase input by the user. Search engine 113 may be anyone of currently available search engines, such Google, Bing, and Yahoo, to name only a few, and any future search engine.

The database 116 is preferably a relational database, although other types of database architectures may be used. For example, the database 116 may be a SQL database, an Access database or an Oracle database, and in any such embodiment have the functionality stored herein. It will be understood that a variety of methods exist for serving the information stored in the database 116, such as ODBC, MySQL and CFML, and the stored information is transmitted via networks 108 and 110.

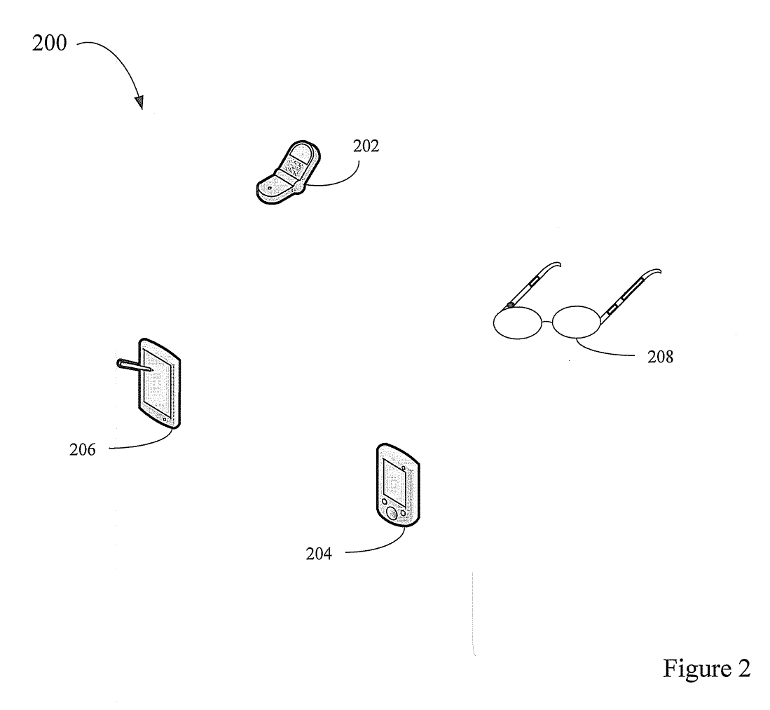

Wireless end user device 104 may include a computing system 105, which in turn includes a processor unit 118, a memory unit 120, a display unit 122, an input unit 124, and a web browser application 125. In accordance with one embodiment, display unit 122 is a reduced display screen, which lacks space to display extensive amount of information, such as long list of phrases or items. As shown in FIG. 2, wireless end user device 104 may be a small-form factor portable (or mobile) electronic device such as a cell phone 202, a personal data assistant (PDA) 204, a tablet or notebook 206, a personal media player device (not shown), a personal headset device (not shown), or a hybrid device that includes any of the above functions. In one embodiment, wireless end user device 104 may be a head wearable display device 208. As such, computing system 105 corresponds to a portion of these different embodiments of wireless end user device 104.

Processor unit 118 is configured to execute instructions and to carry out operations associated with computing system 105. For example, using instructions retrieved from memory unit 120, the processor unit may control the reception and manipulation of input and output data between components of computing system 105. The processor unit can be implemented on a single-chip, multiple chips or multiple electrical components. For example, various architectures can be used for processor unit 118, including dedicated or embedded processor, single purpose processor, controller, application-specific integrated circuit (ASIC), and so forth. In most cases, the processor unit together with an operating system operates to execute computer code and produce and use data.

Memory unit 120 generally provides a place to store computer code and data that are used by computing system 105. The memory unit may include read-only memory (ROM), random-access memory (RAM), a hard disk drive and/or the like. Additional functions and characteristics of the memory unit will be discussed in detail hereafter below.

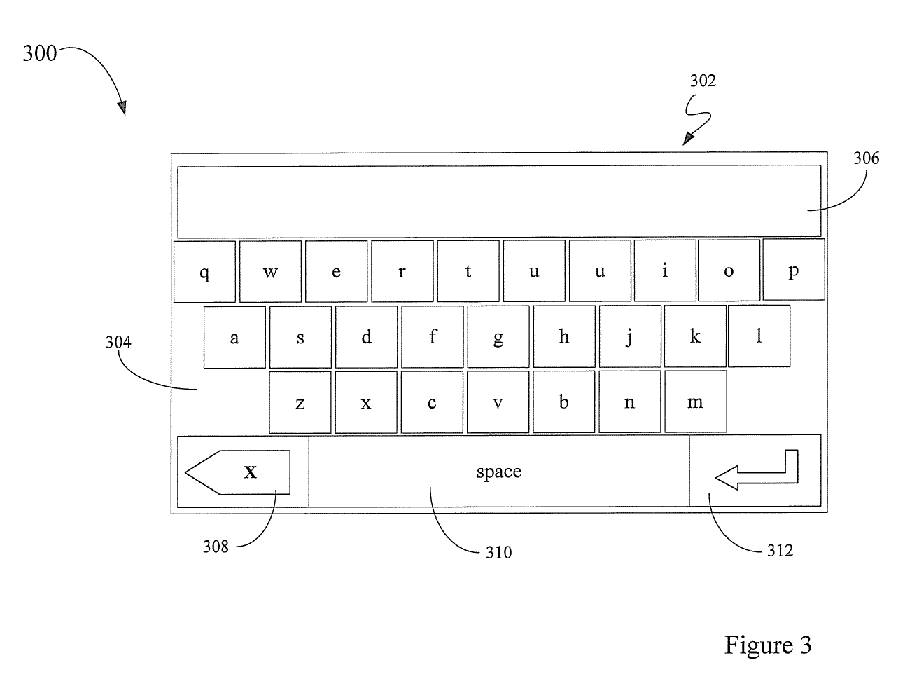

Display unit 122, operatively coupled to processor unit 118 may be a liquid crystal display (LCD) (e.g., active matrix, passive matrix and the like), a light-emitting diode (LED) display, a plasma display, a display implemented with electronic inks, or any other desirable display. Additionally, the display unit may include input characteristics of input unit 124, by displaying a GUI (not shown) that can provide an easy to use interface between a user of computing system 105 and the operating system or an application running thereon. In one embodiment, display unit 122 includes a substantially reduced screen, such as the ones associated with cell phone 202, personal data assistant (PDA) 204, tablet or notebook 206, and head wearable display device 208. One such reduced screen is illustrated in FIG. 3.

As shown in FIG. 3, in one embodiment, display unit 122 is configured to provide an interface screen 302 that includes a virtual keyboard 304. Interface screen 302 may be divided in five (5) rows. The top row or Row 1 is a search or text entry field 306, and Rows 2 to 4 represent the virtual keyboard 304, which holds letters, in a QWERTY format for example, digits, and symbols, depending on the mode of the keyboard. Row 5 includes modifier keys (such as a Shift key), and Backspace 308, Space 310, and Enter 312 keys. In addition to the embodiment shown in FIG. 3, display unit 122 may include anyone of other numerous display and user interface arrangements.

Input unit 124, operatively coupled to processor unit 118, may be used to make selections with respect to the GUI on display unit 122, for example. The input unit may also be used to issue commands to processor unit 118. The input unit may include a touch sensing element, which is configured to receive input from a user's touch and to send this input to processor unit 118. Alternatively, the input unit may include a proximity sensing element, which is configured to receive input when the user's finger is within a predetermined distance from a surface of the proximity sensing element and to send this input to processor unit 118. For the sake of simplicity, hereafter input unit 124 will be considered to include a touch sensing element. The touch sensing element may be a touchpad or a touch screen, each of which may be configured to recognize touch points, in terms of coordinates of their positions as well as their magnitudes on a corresponding touch sensitive surface. The input unit is configured to report data corresponding to the touch points to processor unit 118, which interprets them in accordance with a corresponding programming. For example, the processor unit may initiate a task in accordance with a particular touch. The touch sensing element may be based on sensing technologies including but not limited to capacitive sensing, resistive sensing, surface acoustic wave sensing, pressure sensing, optical sensing, and/or the like. Additionally, the touch sensing element may be configured to detect a single touch point or a plurality of simultaneous touch points.

The input unit may be a touch screen that is integrated with display unit 122. As such, the input unit may be positioned in front, behind, or within a display element of the display unit. When integrated with the display unit, the input unit enables the user to manipulate the GUI directly. For example, the user can simply touch with his/her finger or a stylus a location on the touch screen corresponding to a displayed text or image to be controlled or manipulated. As a touchpad, the input unit is placed away from display unit in a different location. The touchpad typically provides a sensing surface for sliding a finger or a stylus the same way one would use a mouse to scroll a text or an image or to generate a scrolling gesture or motion. Moreover, the touchpad sensing surface can be tapped instead of pressing a button of the mouse.

As known to one of ordinary skill in the art, a user begins a search for information by pointing web browser 125 at a website associated with search engine 113. The user typically interacts with the search engine through a GUI, in which the user inputs text describing the desired search terms or parameters. In use, the user is presented with a text entry or input field in which to enter text describing or related to the information sought. Once the user has entered desired search terms, the user enters an express command to submit the search request to the search engine, such as for example by depressing the “Return” or “Enter” key on a keyboard, or clicking a GUI element, such as a “Submit” button within the browser application or on a web page presented by a web browser application. The search request is then submitted to the search engine based on the search terms input by the user. Results from the search request, typically in the form of links to other websites, documents or files, are then presented to the user for review and selection. The search results are typically presented as the full possibility of word or phrase completions below the entered text. In case the user opts to refine or revise the search terms, the user may add to or modify the text previously entered into the input field, and then again manually submit the search request by entering a submit command, such as by depressing a “Return” key. Alternately, upon typing or entering a few characters of a search term or a few search terms or revising the search terms, computing system 105 may be configured to automatically communicate the entered text to search engine 113 without the user having to enter a “Submit” command, thereby allowing the search engine to provide search results substantially instantly.

As used herein, web browser 125 is a software application program that is used to read, display, locate, download or otherwise access documents (e.g. web pages) or other data resources on the Internet. Web browsers are capable of interpreting or processing “marked up” or coded documents (typically Hypertext Markup Language (HTML)) that reside on web servers and interpret the coding to render a web page. Most web browsers are graphical browsers, which are capable of displaying both text and graphics from web pages. In addition, most browsers are capable of presenting multimedia information, including sound and video.

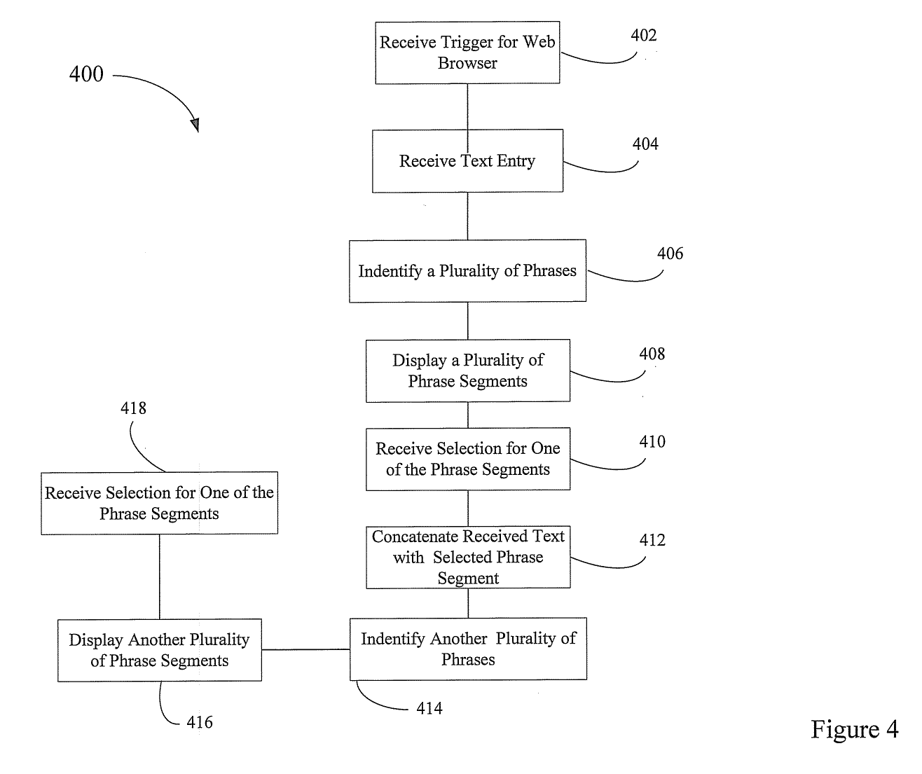

FIG. 4 is a flow diagram that illustrates a method or process 400 for entering text as search terms, for identifying a plurality of phrases that begin with the text entered for an information query, for presenting options or suggestions of a next phrase segment immediately following the received text, without the entered text, and for repeating the process by using the concatenation of the text entered with a selection of the presented suggestions of the next phrase segment as the new search terms.

As shown in FIG. 4, blocks 402 through 410 correspond to receiving text entry, identifying a plurality of phrases that begin with a received text entry, and for presenting suggestions of a next phrase segment immediately following the received text. At block 402, computing system 105 determines whether the user has initiated or triggered web browser 125, by typing the URL of search engine 113 or by selecting it from a list of search engine links, for example. Upon determination of a web browser initiation, computing system 105 is configured to present the user with interface screen 302 to enter search terms or words into text entry field 306 via input unit 124, at block 404. Input search terms include, for example, text (e.g. keywords or portions thereof) or other input corresponding to or describing the desired information sought by the user. Computing system 105 then communicates the entered search terms to search engine 113.

At block 406, based on search results determined by search engine 113, computing system 105 receives a plurality of phrases that each begins with the received text, and that each includes a respective word or phrase segment following the received text. At block 408, computing system 105 displays in text entry field 306 the plurality of respective words or phrase segments in text entry field 306, without the received text. In one embodiment, rather than displaying the plurality of phrase segments, computing system 105 displays only the first word or term of each of the plurality of phrase segments, thereby culling down the search results to just the next words of the received plurality of phrases.

In one embodiment, as the user starts the query and begins typing characters or letters of a first search term or word in text entry field 306, computing system 105 provides the user, before completing the typing of the first word, with auto-complete alternatives or completion suggestions. These completion suggestions may be determined by computing system 105 based on prior search entries, favorite web sites, documents previously sought or accessed, text messaging, emailing, and the like. As such, in this embodiment, computing system 105 is configured to require the user to break out of the text entering process, after entering only a portion of a search word, to select from a list of suggested search terms, e.g., words or phrase segments, displayed in text entry field 306. Upon selection of one of the suggested search terms, computing system 105 communicates the selected search term to search engine 113 to trigger the information search.

Alternately, in one embodiment, whenever computing system 105 determines that the user has initiated a message drafting session, as the user types in characters or letters of terms or words in text entry field 306, computing system 105 may provide the user, before completing the typing of each word, with auto-complete alternatives or completion suggestions. These completion suggestions may be determined by computing system 105 based on prior messages received or communicated, such as for text messaging or emailing, documents previously sought or accessed, standard dictionary of words, and the like. As such, in this embodiment, computing system 105 is configured to require the user to break out of the text entering process, after entering only a portion of a word, to select from a list of suggested words, displayed in text entry field 306. This typing and completion suggestion cycle may be repeated for each typing of new characters until completion of the message drafting session.

In one embodiment, upon typing a few characters of search input, an auto-complete feature may present the user via user interface 306 with one or more suggested search terms in an attempt to anticipate what the user may be trying to type, based on the characters already input by the user. For example, if a user types in part of a keyword in text entry field 306, computing system 105 may automatically provide a plurality of auto-completions of the keyword for the user according to previously input keywords, standard dictionary of words, or historical web searches. Further, an auto-correct feature may suggest correctly spelled search terms when a user appears to have typed a misspelled word.

In one embodiment, upon identification and receipt of the plurality of phrases that each begins with the received keyword, and that each includes a respective word or phrase segment following the received keyword, computing system 105 is configured to break up all identified phrases to create a table of the respective words, and to rank them, based on the user historical web activities for example. Computing system 105 is further configured to present them to the user, based on their ranking for example, in a plurality of lists, each fitting separately in text entry field 306. Computing system 105 enables the user to view each list in text entry field 306 until a selection of one the listed respective words is detected.

To perform a selection of one of the suggested terms or respective words listed in text entry field 306, the user may use a pointing device to click on or a finger/stylus to tap on or touch an area of input unit 118 corresponding to one of the suggested terms or respective words. At block 410, computing system 105 enables the user to make a selection of one of the suggested phrase segments. Alternately, instead of making a selection, computing system 105 allows the user to correct already entered text if not already corrected by the auto-correct feature, or to discard the already entered or corrected text and enter new search characters.

In one embodiment, upon typing or entering a few characters of a search input word, computing system 105 communicates the partially entered word to search engine 113. Upon receipt of the partial word, search engine 113 identifies a plurality of word completions, and communicates it to computing system 105, which in turn presents it as a plurality of word suggestions to the user via text entry field 306. As such, search queries can be triggered character by character entry or by word by word entry. This on-the-fly or as-you-type searches allow the user to be presented with search results before the user has completed his/her intended search input, which may result in the user finding desired result(s) more quickly than he/she would have otherwise (e.g. if a complete query has been entered and then manually submit the search request).

As shown in FIG. 4, blocks 412 through 418 correspond to concatenating the entered text with the selected phase segment, and repeating the information search process by using the concatenated text as the search input. As such, in case the user opts to select one of the suggested phrase segments, computing system 105 is configured to automatically concatenate the entered text with the selected phase segment, which may be a single word, at block 412, and communicates the concatenated text to search engine 113.

Upon receiving the concatenated text, search engine 113 proceeds to identify a second plurality of phrases that each begins with the concatenated text, and that each includes a respective word or phrase segment following the concatenated text, at block 414. At block 416, computing system 105 displays the second plurality of phrase segments in text entry field 306, without the concatenated text. At block 418, computing system 105 enables the user to make a selection of one of the suggested second plurality of phrase segments. Once the user has selected one of the suggested second plurality of phrase segments, computing system 105 is configured to again concatenate the concatenated text with the selected phase segment, and to communicate it to the search engine.

In one embodiment, if additional search input is received while there is a pending or in-progress search request (i.e. the results for a submitted search request have not yet been provided by search engine 113 to computing system 105), the pending search request may be cancelled and replaced by a new search request including the additional received search input entered in text entry field 306. Thus, in one embodiment, a prioritization of a more complete or more recent input from the user is enabled and the more complete or more recent input is communicated to search engine 113 to perform corresponding searches.

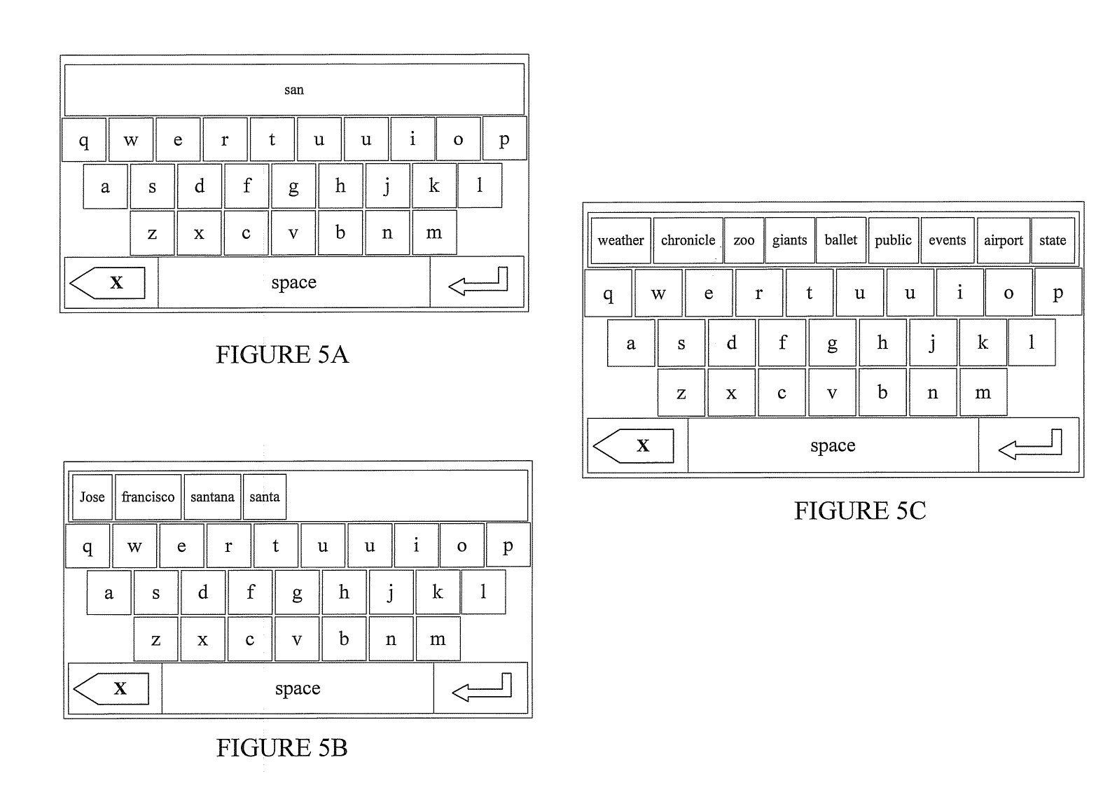

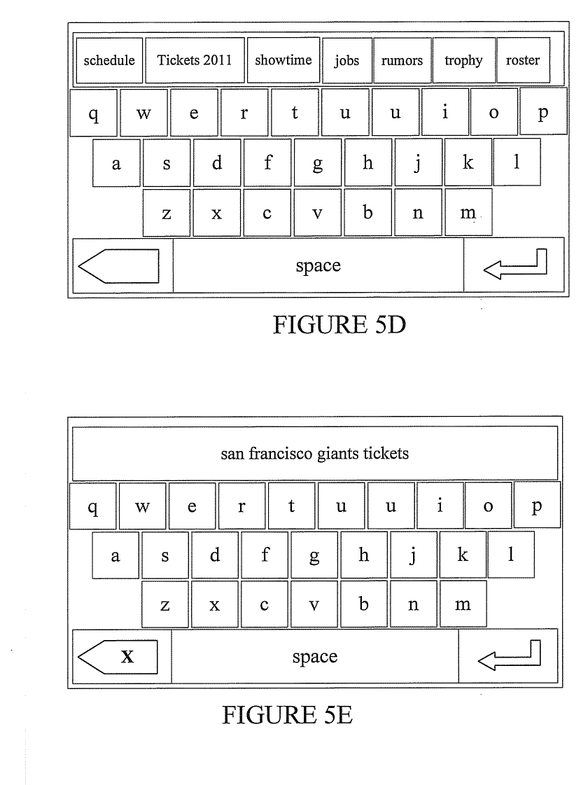

With reference to FIGS. 5A-5E, as an example of the above discussed process or method 400, the user can enter a search query “san” in text entry field 306 to query for “san francisco giants tickets.” This search may be performed by any current or future search engine. According to the method 400, once the user enters “san” in text entry field 306 of interface screen 302, as shown in FIG. 5A, computing system 105 communicates the “san” entry to search engine 113, which then returns a first list of phrases that each begins with the received text “san” and that each includes a respective phrase segment immediately following the received text. For example, the first list of phrases may be as follows:
san jose mercury news,
san jose sharks,
san francisco weather,
santana row,
san francisco chronicle,
san francisco zoo,
sanjose state,
santa clara university,
santa cruz,
san Francisco.

In response, computing system 105 configures user interface screen 102 to display only a subset of respective words, based on historical user search activities for example, following the received text, namely jose, francisco, santana, and santa, as shown in FIG. 5B. Upon selection by the user of the listed word “franscico,” computing system 105 concatenates the words “san” and “francisco” to produce the new search terms, and communicates these concatenated words to search engine 113.

In response, search engine 113 identifies and provides to computing system 105 a second list of phrases that each begins with the received text “san francisco” and that each includes a respective phrase segment immediately following the received text. For example, the second list of phrases may be as follows:
san francisco weather,
san francisco chronicle,
san francisco zoo,
san francisco giants,
san francisco ballet,
san francisco public library,
san francisco events,
san francisco airport,
san francisco state.

In response, computing system 105 configures user interface screen 102 to display only a subset of respective words, based on historical user search activities for example, following the concatenated words, namely weather, chronicle, zoo, giants, ballet, public, events, airport, and state, as shown in FIG. 5C. Upon selection by the user of the listed word “giants,” computing system 105 concatenates the previously concatenated words “san francisco” with “the word “giants” to produce the new search terms, and communicates these new concatenated words to search engine 113.

In response, search engine 113 identifies and provides to computing system 105 a third list of phrases that each begins with the received text “san francisco giants” and that each includes a respective phrase segment immediately following the received text. For example, the third list of phrases may be as follows:
san franscisco giants schedule,
san franscisco giants tickets,
san franscisco giants 2011 schedule,
san franscisco giants showtime,
sanfranscisco giants jobs,
san franscisco giants rumors,
san franscisco giants trophy tour,
san franscisco giants roster.

In response, computing system 105 configures user interface screen 102 to display only a subset of respective words, based on historical user search activities, for example, following the recently concatenated words text, namely schedule, tickets, 2011, showtime, jobs, rumors, trophy, and roster, as shown in FIG. 5D. At this point of the search query, the user selects “tickets” and completes his/her query, and computing system 105 displays again concatenated the result of the user's last selection, namely “san francisco giants tickets.”

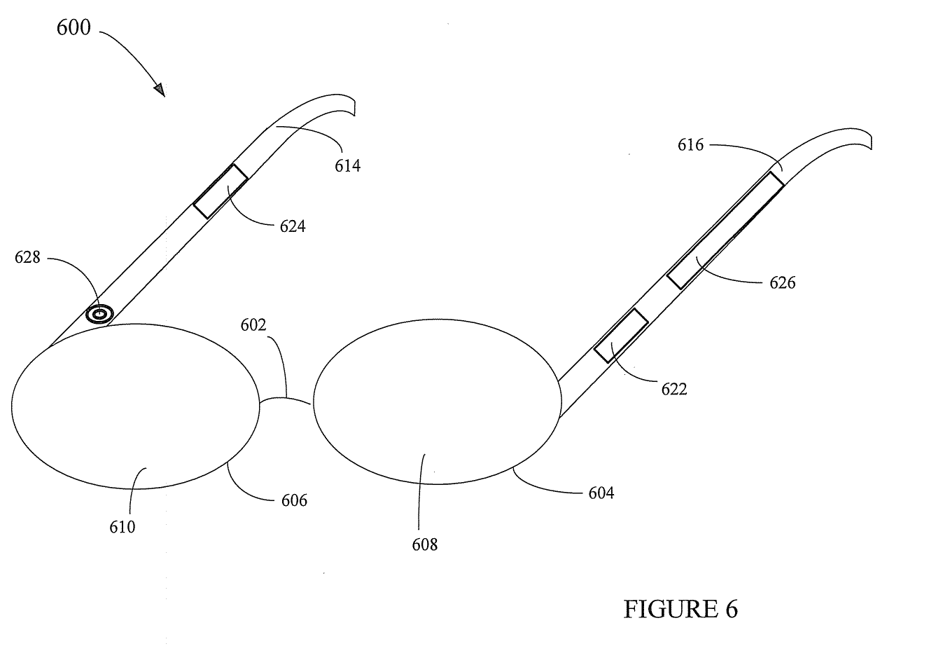

The above discussed method and system for managing phrase completion suggestions in response to text input may be implemented in various arrangements. One such arrangement may include a head wearable display device 600, as shown in FIG. 6.

FIG. 6 illustrates an example embodiment of a head wearable display device 600 suitable for continuous, daily use as a wearable personal electronics device. While FIG. 600 illustrates glasses 602 as an example of a wearable heads-up display device 600, other types of wearable heads-up displays could additionally or alternatively be used. In addition, other wearable electronic devices (such as a wrist watch), or other non-wearable electronic devices, such as a mobile phone or laptop computer could be used.

As illustrated in FIG. 6, glasses 602 comprise frame elements including lens frames 604, 606, respective lens elements 608 and 610, center frame support 612, two stems or temples 614 and 616, and planar direction input units 622, 624. The center support 612 and the two rearward extending stems 614 and 616 are configured to secure the glasses 602 to a user's face via a user's nose and ears, respectively. Each of the frame elements 604, 606, 612 and stems 614, 616 may be formed of a solid structure of plastic, metal, ceramic, etc., or may be formed of a hollow structure of similar material so as to allow wiring and component interconnects to be internally routed through glasses 602. Each of stems 614 and 616 is an example of a projection that extends away from a display element and is used to secure the display element to a user.

As shown in FIG. 6, glasses 602 further include a computing device 626 and a miniature projector unit 628 coupled to an inside-surface of stem 614 and configured to project a display onto an inside-surface of lens 610. In one embodiment, computing device 626 may be incorporated into the glasses 102. In another embodiment, computing device 626 may be a head-mounted computing device incorporated into, for example, a hat or helmet, or may be a body-mounted computing device incorporated into, for example, a waist-mounted mobile phone or personal digital assistant. Computing device 626 is coupled to planar direction input units 622, 624 and to miniature projector unit 628. As such, computing device 626 is configured to transmit input received from planar direction input devices 622, 624, and to transmit display data to miniature projector unit 628 for display on lens 610. Additionally, glasses 602 may further include a movement sensor (not shown), and a microphone (not shown), among other possible input units.

During operation, the user may use his/her finger to select a specific letters associated with virtual keyboard 304 by tapping on corresponding areas of one of planar direction input devices 622, 624 to enter a corresponding search term in text entry field 306 to trigger a search for information by search engine 113, and to select one of the search results suggested by computing system 105 listed in text entry 306.

Alternately, glasses 602 may include an eye monitoring unit (not shown) positioned on lens frame 606 associated with temple 614, on which is positioned projector unit 628. The eye monitoring unit is configured to track the user's eye movements to determine where the user's eye is gazing. The eye monitoring unit is coupled to computing device 626 to communicate which area of lens element 610 the user is looking at. When the eye monitoring unit determines that the user's eye has been gazing for a predetermined time at a particular area on interface screen 302, projected on lens element 610 by projector unit 628, then this particular area is selected as the user's selection to be communicated to computing device 626. This particular area may correspond to a key of virtual keyboard 304 for entry in text entry 306 or to a displayed text in text entry 306 for selection as a search term, which may trigger a search for information by search engine 113.

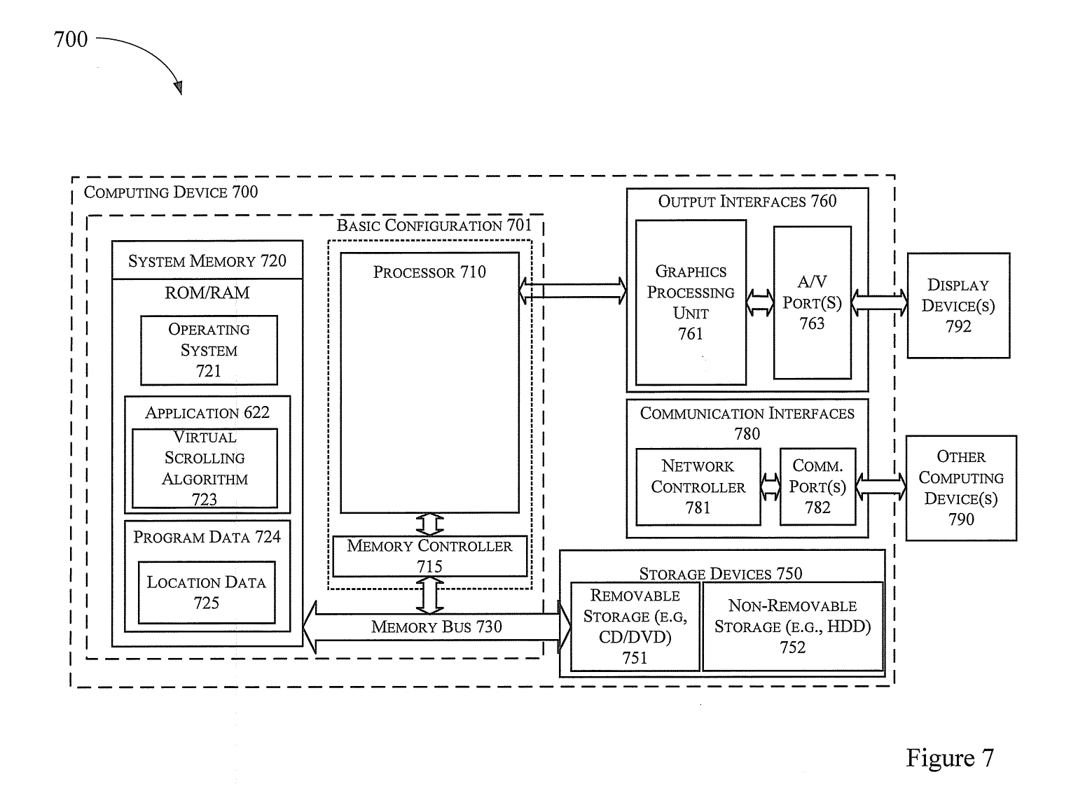

In accordance with an embodiment of the method for managing phrase completion suggestions in response to text input, computing system 105 includes memory unit 120, which in turn includes a non-transitory computer readable storage medium, discussed hereafter with regard to FIG. 7 that contains instructions that cause computing system 105 to perform the method.

FIG. 7 is a functional block diagram illustrating an example computing device 700 used in a computing system 100 that is arranged in accordance with at least some embodiments described herein. The computing device may be a personal computer, mobile device, cellular phone, video game system, or global positioning system. In a very basic configuration 701, computing device 700 may typically include one or more processors 710 and system memory 720. A memory bus 730 can be used for communicating between the processor 710 and the system memory 720. Depending on the desired configuration, processor 710 can be of any type including but not limited to a microprocessor (μP), a microcontroller (μC), a digital signal processor (DSP), or any combination thereof. A memory controller 715 can also be used with the processor 710, or in some implementations, the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes one or more applications 722, and program data 724. Application 722 may include a virtual scrolling algorithm 723 that is arranged to provide inputs to the electronic circuits, in accordance with the present disclosure. Program data 724 may include location data 725 that could provide location data to the electronic circuits. In some example embodiments, application 722 can be arranged to operate with program data 724 on an operating system 721. This described basic configuration is illustrated in FIG. 7 by those components within dashed line 701. Operating systems are generally well known and will not be described in greater detail. By way of example, the operating system may correspond to OS/2, DOS, Unix, Linux, Palm OS, and the like. The operating system can also be a special purpose operating system, such as may be used for limited purpose appliance-type computing devices.

Computing device 700 can have additional features or functionality, and additional interfaces to facilitate communications between the basic configuration 701 and any devices and interfaces. For example, the data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, removable and non-removable media implemented in any method or technology for storage of information, such as computer readable instructions, data structures, program modules, or other data.

System memory 720, removable storage 751, and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include output interfaces 760 that may include a graphics processing unit 761, which can be configured to communicate to various external devices such as display devices 792 or speakers via one or more A/V ports 763 or a communication interface 780. A communication interface 780 may include a network controller 781, which can be arranged to facilitate communications with one or more other computing devices 790 over a network communication via one or more communication ports 782. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

It should be further understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

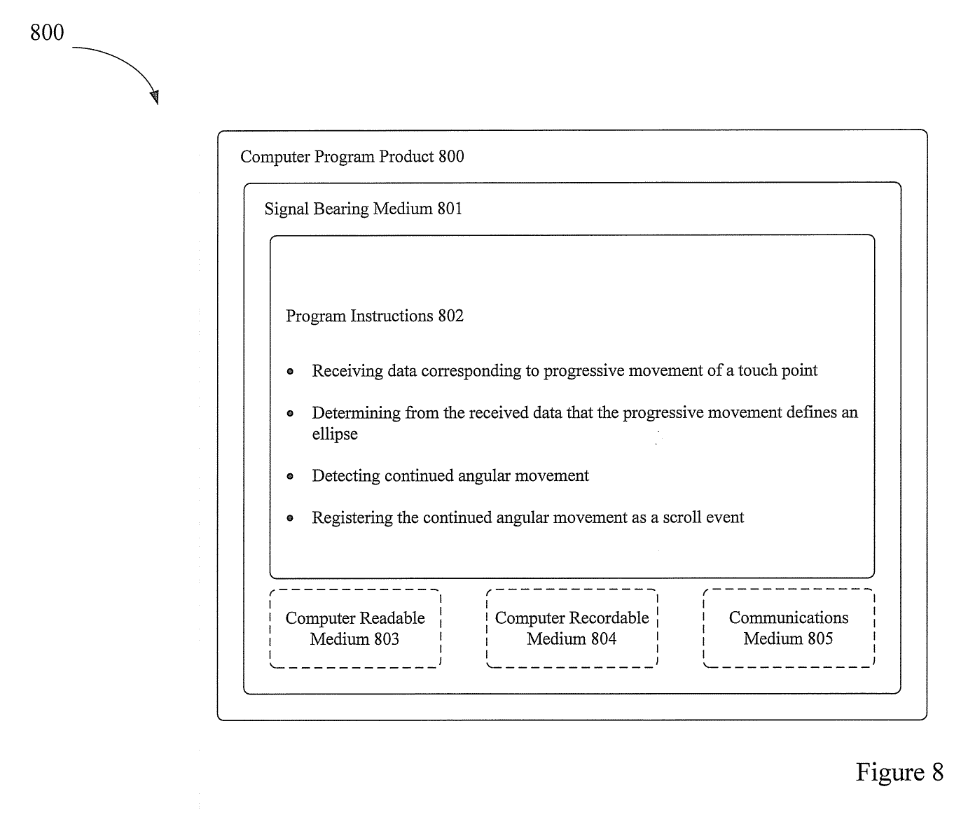

In some embodiments, the disclosed methods may be implemented as computer program instructions encoded on a computer-readable storage media in a machine-readable format. FIG. 8 is a schematic illustrating a conceptual partial view of an example computer program product 800 that includes a computer program for executing a computer process on a computing device, arranged according to at least some embodiments presented herein. In one embodiment, the example computer program product 800 is provided using a signal bearing medium 801. The signal bearing medium 801 may include one or more programming instructions 802 that, when executed by one or more processors may provide functionality or portions of the functionality described above with respect to FIGS. 1-7. Thus, for example, referring the embodiment shown in FIG. 4, one or more features of blocks 402, 404, 406, 408, 410, 412, 414, 416 and/or 418 may be undertaken by one or more instructions associated with the signal bearing medium 801.

In some examples, the signal bearing medium 801 may encompass a non-transitory computer-readable medium 803, such as, but not limited to, a hard disk drive, a Compact Disc (CD), a Digital Video Disk (DVD), a digital tape, memory, etc. In some implementations, the signal bearing medium 801 may encompass a computer recordable medium 804, such as, but not limited to, memory, read/write (R/W) CDs, R/W DVDs, etc. In some implementations, the signal bearing medium 801 may encompass a communications medium 805, such as, but not limited to, a digital and/or an analog communication medium (e.g., a fiber optic cable, a waveguide, a wired communications link, a wireless communication link, etc.). Thus, for example, the signal bearing medium 801 may be conveyed by a wireless form of the communications medium 805 (e.g., a wireless communications medium conforming with the IEEE 802.11 standard or other transmission protocol).

The one or more programming instructions 802 may be, for example, computer executable and/or logic implemented instructions. In some examples, a computing device such as the computing device 600 of FIG. 6 may be configured to provide various operations, functions, or actions in response to the programming instructions 802 conveyed to the computing device 600 by one or more of the computer readable medium 803, the computer recordable medium 804, and/or the communications medium 805.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

1. In a computing system, a method for managing phrase completion suggestions in response to text input, the method comprising:
receiving text entered into the computing system;
identifying a first plurality of phrases that each begins with the received text and that each includes a respective phrase segment immediately following the received text;
based on web activity of the computing system, determining ranks associated with respective phrases of the first plurality of phrases;
based on the ranks of the respective phrases of the first plurality of phrases, displaying a first list of the respective phrase segments of the identified first plurality of phrases without displaying the received text; and
receiving input defining a selection of one of the respective phrase segments of the displayed first list.

2. The method of claim 1, further comprising:
concatenating the received text with the selected respective word so as to define concatenated text;
identifying a second plurality of phrases that each begins with the concatenated text and that each includes a respective phrase segment immediately following the concatenated text;
displaying a second list of the respective phrase segments of the identified second plurality of phrases without displaying the concatenated text; and
receiving input defining a selection of one of the respective phrase segments of the displayed second list.

3. The method of claim 2, wherein receiving text entered into the computing system comprises:
receiving text input within a search field of a web browser application.

4. The method of claim 3, further comprising:
displaying the first list of the respective phrase segments in the search field of the web browser application.

5. The method of claim 3, further comprising:
displaying the second list of the respective phrase segments in the search field of the web browser application.

6. The method of claim 1, wherein identifying a first plurality of phrases comprises:
submitting the received text to a search engine based on the characteristics of the received text.

7. The method of claim 1, wherein the search engine is configured to search through sent and received text messages to identify phrases that include the received text.

8. A computer non-transitory readable storage medium containing instructions that cause a computing system to perform a method to perform managing phrase completion suggestions in response to text input, the method comprising:
receiving text entered into the computing system;
identifying a first plurality of phrases that each begin with the received text and that each include a respective phrase segment immediately following the received text;
based on web activity of the computing system, determining ranks associated with respective phrases of the first plurality of phrases;
based on the ranks of the respective phrases of the first plurality of phrases, displaying a first list of the respective phrase segments of the identified first plurality of phrases without displaying the received text; and
receiving input defining a selection of one of the respective phrase segments of the displayed first list.

9. The method of claim 1, further comprising:
concatenating the received text with the selected respective phrase segments so as to define concatenated text;
identifying a second plurality of phrases that each begin with the concatenated text and that each include a respective phrase segment immediately following the concatenated text;
displaying a second list of the respective phrase segments of the identified second plurality of phrases without displaying the concatenated text; and
receiving input defining a selection of one of the respective words of the displayed second list.

10. The computer readable storage medium of claim 8, wherein receiving text entered into the computing system comprises:
receiving text input within a search field of a web browser application.

11. The computer readable storage medium of claim 10, further comprising:
displaying the first list of the respective words in the search field of the web browser application.

12. The computer readable storage medium of claim 10, wherein identifying a first plurality of phrases comprises:
submitting the received text to a search engine based on the characteristics of the received text.

13. The computer readable storage medium of claim 8, wherein the search engine is configured to search through sent and received text messages to identify phrases that include the received text.

14. A computing system, comprising:
a display unit operable to display a search field and keys constituting a virtual keyboard;
a memory unit for storing program instructions executable to perform a method for managing phrase completion suggestions in response to text input, the method comprising: a) receiving text entered into the search field via the virtual keyboard, b) identifying a first plurality of phrases that each begins with the received text and that each include a respective word immediately following the received text, c) based on web activity of the computing system, determining ranks associated with respective phrases of the first plurality of phrases, d) based on the ranks of the respective phrases of the first plurality of phrases, e) displaying a first list of the respective words of the identified first plurality of phrases in the search field without displaying the received text, and f) receiving input defining a selection of one of the respective words of the displayed first list; and
a processor operatively coupled to the memory and the display unit, and configured to execute the method.

15. The computing system of claim 14, the method further comprising:
e) concatenating the received text with the selected respective word so as to define concatenated text;
f) identifying a second plurality of phrases that each begin with the concatenated text and that each include a respective word immediately following the concatenated text;
g) displaying a second list of the respective words of the identified second plurality of phrases without displaying the concatenated text; and
h) receiving input defining a selection of one of the respective words of the displayed second list.

16. The computing system of claim 14, wherein receiving text entered into the computing system comprises:
receiving text input within a search field of a web browser application.

17. The computing system of claim 16 further comprises:
displaying the first list of the respective words in the search field of the web browser application.

18. The computing system of claim 14, wherein identifying a first plurality of phrases comprises:
submitting the received text to a search engine based on the characteristics of the received text.

19. The computing system of claim 18, wherein the search engine is an Internet engine.

20. The computing system of claim 18, wherein the search engine is configured to search through sent and received text messages to identify phrases that include the received text.

21. A head-wearable display device, comprising:
a display element for displaying a search field and keys constituting a virtual keyboard;
an image projecting unit for projecting the search field and the virtual keyboard on the display element;
a touch pad configured to generate a signal generated by a touch contact on the touchpad, wherein the signal is indicative of a selection in the search field or on the virtual keyboard;
a memory unit for storing program instructions executable to perform a method for managing phrase completion suggestions in response to text input, the method comprising: a) receiving text entered into the search field via the virtual keyboard, b) identifying a first plurality of phrases that each begins with the received text and that each include a respective word immediately following the received text, c) based on activity of the virtual keyboard, determining ranks associated with respective phrases of the first plurality of phrases, d) based on the ranks of the respective phrases of the first plurality of phrases, e) displaying a first list of the respective words of the identified first plurality of phrases in the search field without displaying the received text, and f) receiving input defining a selection of one of the respective words of the displayed first list; and
a processor operatively coupled to the memory and the display unit, and configured to execute the method.

22. The head-wearable display device of claim 21, further comprising:
e) concatenating the received text with the selected respective word so as to define concatenated text;
f) identifying a second plurality of phrases that each begin with the concatenated text and that each include a respective word immediately following the concatenated text;
g) displaying a second list of the respective words of the identified second plurality of phrases in the search field without displaying the concatenated text; and
h) receiving input from the touch pad defining a selection of one of the respective words of the displayed second list.

23. The head-wearable display device of claim 21, wherein identifying a first plurality of phrases comprises:
submitting the received text to a search engine based on the characteristics of the received text.
